(19) United States
(12) Patent Application Publication
(10) Pub. No.: US 2026/0133869 A1
(43) Pub. Date: May 14, 2026

(54) SYSTEM AND METHOD FOR AUTOMATED ROOT CAUSE ANALYSIS

(71) Applicant: NICE LTD., Ra'anana (IL)

(72) Inventors: Gennadi LEMBERSKY, Haifa (IL); Or GERSHON, Petah Tikva (IL); Shay DINER, Holon (IL)

(73) Assignee: NICE LTD., Ra'anana (IL)

(21) Appl. No.: 18/946,404

(22) Filed: Nov. 13, 2024

(51) Int. Cl. G06F 11/07

(52) U.S. Cl. CPC G06F 11/079

(57) ABSTRACT

Systems and methods for evaluating and determining a root cause of a change in performance in a workforce management system are provided. Graphs can be created based on key performance indicators, behaviors and metrics to determined a root cause for agents who have a decrease in performance. The root cause can be transmitted to other computing systems which can select which interactions to record, selects a coaching program to run, or any combination.

### TECHNICAL FIELD OF THE INVENTION

The present invention relates generally to workforce management systems. In particular, to root cause analysis that utilizes causal graph technology to identify the effect of each factor on a change in KPI.

### BACKGROUND OF THE INVENTION

Current workforce management systems typically automatically track and manage many aspects of agent performance. For example, how many requests (e.g., calls or chats) agents answered, average interaction handle time each month, how many times an agent asks the same question, how many interactions were successful, how many interactions had positive versus negative sentiment, how much time spent on the interactions, and/or closure of the interactions, e.g., after call work. Current workforce management systems can track and determine when specific agents start to perform worse, with respect to themselves and/or teammates.

Automatically tracking agent performance can be beneficial and provide management with information regarding the agent's performance that otherwise is not available without the workforce management system. However, current workforce management systems fail to determine a root cause for the change.

Therefore, it can be desirable to determine a root cause for changes in key performance metrics for agents analyzed in the workforce management system. For example, for a workforce management system that determines a number of times an agent asks the same question is increasing, which can lead to interaction dissatisfaction, it can be desirable to know if a root cause of that increase is that there is a new topic, new service, new product, agent personal life issues or other factors can contribute to the increase.

Being unable to identify a root cause of changes in agent performance by workforce management systems can cause slower resolution time in addressing the root cause, increased cost of operating a call center (e.g., due to agent turnover, longer call times, increased hold times, and/or inadequate coaching.)

Therefore, it can be desirable to provide a root cause analysis for workforce management systems.

### SUMMARY OF THE INVENTION

Improvements and advantages of embodiments of the invention may include automatically generating a trust indicator for assessing a legal entity that combines risk factors and assesses the quality of data present in the risk factors by determining a data incompleteness score. Embodiments may more accurately determine a trust indictor for a legal entity.

In one aspect, the invention involves a computerized method for evaluating and determining a root cause of a change in performance in a workforce management system. The method can involve determining, by a processor, a causal graph based on key performance indicators, behaviors, and metrics. The method can also involve determining, by the processor, one or more agents of a plurality of agents that have a decrease in performance based on key performance indicators. The method can also involve for each of the one or more agents i) creating, by the processor, a first causal graph that is for a current time period, ii) creating, by the processor, a second causal graph that is for a second time period, iii) determining, by the processor, which of one or more metrics, one or more behaviors or a combination thereof is the root cause of a change in performance for the current one or more agent, and iv) transmitting, by the processor, the root cause to another computing system that selects a coaching program to run based on the root cause, to another computing system that selects which interactions to record, to a display, or any combination thereof.

In some embodiments, determining the one or more agents that have a decrease in performance can also involve determining a difference between the key performance indicators for a first time period and a second time period for each of the plurality of agents. In some embodiments, creating the first casual graph and the second causal graph can also involve training a linear regression based on nodes of the respective causal graph and edges of the respective causal graph.

In some embodiments, the one or more metrics, one or more behaviors or a combination thereof, that the causal graph is based on are received from a database, input through a graphical user interface, or any combination thereof.

In some embodiments, determining the root cause further comprises, for each node in the first causal graph, isolate a contribution from other nodes to the value of the respective node from the contribution of the node itself to the value of the respective node.

In some embodiments, determining the root cause further comprises identifying which node has a biggest effect on the value and whether a change in value has a negative or positive effect on performance based on a type of the one or more metrics or the one or more behaviors of the node. In some embodiments, determining one or more agents that have decreased in performance further comprising receiving, by the processor, the key performance indicators from another computing device, a graphical user interface, or any combination thereof.

In another aspect, the invention includes a system for evaluating and determining a root cause of a change in performance in a workforce management system. The system can includes a computing device, a memory, and a processor. The processor can be configured to determine a causal graph based on key performance indicators, behaviors, and metrics. The processor can be configured to determine one or more agents of a plurality of agents that have a decrease in performance based on key performance indicators. The processor can be configured to for each of the one or more agents i) create a first causal graph that is for a current time period, ii) create a second causal graph that is for a second time period, iii) determine which of one or more metrics, one or more behaviors or a combination thereof is the root cause of a change in performance for the current one or more agent, and iv) transmit the root cause to another computing system that selects a coaching program to run based on the root cause, to another computing system that selects which interactions to record, to a display, or any combination thereof.

In some embodiments, to determine the one or more agents that have a decrease in performance the processor is further configured to determine a difference between the key performance indicators for a first time period and a second time period for each of the plurality of agents. In some embodiments, to create the first casual graph and the second causal graph the processor is further configured to train a linear regression based on nodes of the respective causal graph and edges of the respective causal graph.

In some embodiments, the one or more metrics, one or more behaviors or a combination thereof, that the causal graph is based on are received from a database, input through a graphical user interface, or any combination thereof. In some embodiments, to determine the root cause the processor is further configured to for each node in the first causal graph, isolate a contribution from other nodes to the value of the respective node from the contribution of the node itself to the value of the respective node.

In some embodiments, to determine the root cause the processor is further configured to identify which node has a biggest effect on the value and whether a change in value has a negative or positive effect on performance based on a type of the one or more metrics or the one or more behaviors of the node.

In some embodiments, to determine one or more agents that have decreased in performance the processor is further configured to receive the key performance indicators from another computing device, a graphical user interface, or any combination thereof.

In another aspect, the invention includes a non-transitory computer program product comprising instruction which, when the program is executed cause the computer to determine a causal graph based on key performance indicators, behaviors, and metrics. The non-transitory computer program product can also comprise instructions which, when the program is executed cause the computer to determine one or more agents of a plurality of agents that have a decrease in performance based on key performance indicators. The non-transitory computer program product can also comprise instruction which, when the program is executed cause the computer to for each of the one or more agents i) create a first causal graph that is for a current time period, ii) create a second causal graph that is for a second time period, iii) determine which of one or more metrics, one or more behaviors or a combination thereof is a root cause of a change in performance for the current one or more agent, and iv) transmit the root cause to another computing system that selects a coaching program to run based on the root cause, to another computing system that selects which interactions to record, to a display, or any combination thereof.

In some embodiments, the non-transitory computer program product can also comprise instruction which, when the program is executed cause the computer to determine the one or more agents that have a decrease in performance the processor is further configured to determine a difference between the key performance indicators for a first time period and a second time period for each of the plurality of agents.

In some embodiments, the non-transitory computer program product can also comprise instruction which, when the program is executed cause the computer to create the first casual graph and the second causal graph the processor is further configured to train a linear regression based on nodes of the respective causal graph and edges of the respective causal graph.

In some embodiments, wherein the one or more metrics, one or more behaviors or a combination thereof, that the causal graph is based on are received from a database, input through a graphical user interface, or any combination thereof.

In some embodiments, the non-transitory computer program product can also comprise instruction which, when the program is executed cause the computer to determine the root cause the processor is further configured to for each node in the first causal graph, isolate a contribution from other nodes to the value of the respective node from the contribution of the node itself to the value of the respective node.

In some embodiments, the non-transitory computer program product can also comprise instruction which, when the program is executed cause the computer to determine the root cause the processor is further configured to identify which node has a biggest effect on the value and whether a change in value has a negative or positive effect on performance based on a type of the one or more metrics or the one or more behaviors of the node.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is flowchart for a method for evaluating and determining a root cause of a change in performance in a workforce management system, according to some embodiments of the invention.

FIG. 3 is an example of casual graph, according to some embodiments of the invention.

FIG. 4 is a sequence diagram for determining one or more agents of a plurality of agents that have a decrease in performance based on key performance indicators, according to some embodiments of the invention.

FIG. 5 is a sequence diagram for creating a current casual graph and a past causal graph, according to some embodiments of the invention.

FIGS. 6A, 6B and 6C are an example of determining which of the key performance indicators it the root cause of change in performance, according to some embodiments of the invention.

FIG. 7 is a sequence diagram 700 for determining which of the key performance indicators it the root cause of change in performance for the current one or more agent, according to some embodiments of the invention.

FIG. 8 is a system architecture for a cloud-based contact center, according to some embodiments of the invention.

FIG. 9 shows an example of a coaching package graphical user interface, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

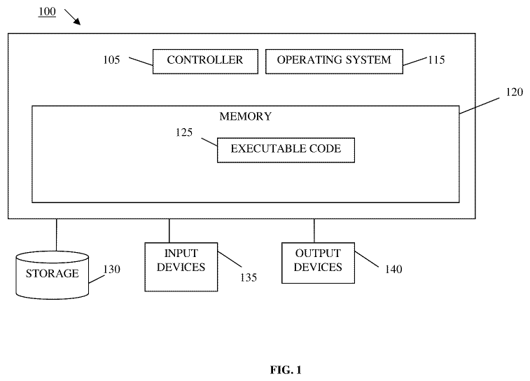

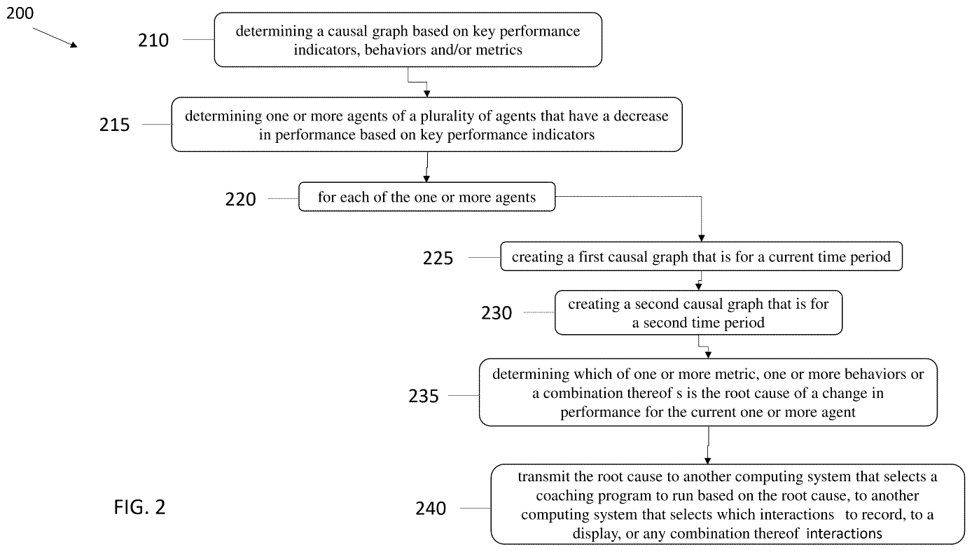

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. computing device 202, legal entity device 210, device 220, input engine 502, platform engine 504, and modules and processes in FIGS. 2, 3, 4, 5, 8, 9 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

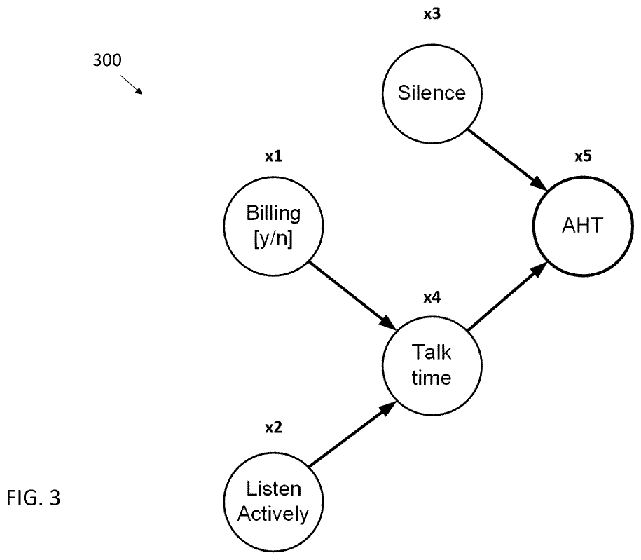

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In general, the invention can involve, for a given agent, determining a root cause of a decrease in performance. The root cause analysis can include automatically identifying a contributing factor (e.g., KPI, metric and/or behavior) that contributes most significantly to the decrease in performance. The automatic identification of the root cause can allow for more accurate results in comparison to a human manager attempting to identify a root cause. The root cause analysis algorithm can produce more accurate results, and insight into the power of a causal relationship between a KPI, and its contributing metrics and behaviors, and/or a contribution of the KPI itself.

FIG. 2 is flowchart 200 for a method for evaluating and determining a root cause of a change in performance in a workforce management system, according to some embodiments of the invention.

The method can involve determining (e.g., by a processor 105 as described above in FIG. 1), a causal graph (e.g., initial causal graph) based on key performance indicators, behaviors and/o metrics (Step 210). The input to the causal graph can be historical values of metrics, key performance indicators (KPIs) and/or behaviors. KPIs can be a measure of performance, metrics can be factors that contribute to the KPIs, and behaviors can also contribute to the KPIs. For example, assume blood pressure is the KPI, metrics such as age and weight, and behaviors such as eating habits and smoking can contribute to the KPI of blood pressure. In another example, customer satisfaction is the KPI, metrics such as call duration and/or behaviors such as call transfer or hold can contribute to the KPI.

The input to the casual graph can be pulled from a file of historical data, input by a user through a graphical user interface or any combination thereof.

The input to the initial casual graph can be based on data collected for agents over a predetermined time period. The predetermined time period can be a month, a week or any user input time period.

Turning to FIG. 3, FIG. 3 is an example of casual graph 300, according to some embodiments of the invention. Assume a KPI of Average Handling Time (AHT). The causal graph can include metrics and behaviors that effect the AHT.

The causal graph edges can represent causal relations as functions (e.g., linear functions):
xᵢ=f(parent(xᵢ), ϵ) where ϵ is a direct contribution of xᵢ independent of its parents.

As shown in FIG. 3, the metrics of billing (x1) effects the metric of talk time (x4) and the behaviors of listen actively (x2) effects talk time (x4). Talk time (x4) and silence (x3) effect the KPI of AHT (x5). However, as is apparent to one of ordinary skill in the art, all of the metrics and behaviors direct or indirectly effect AHT (x5).

Turning back to FIG. 2, the method can also involve determining (e.g., by the processor), one or more agents of a plurality of agents that have a decrease in performance based on key performance indicators (Step 215). The plurality of agents can be input by a user, and/or received (or retrieved) from one or more workforce engagement management applications that can automatically identify agent's metrics, e.g., month over month.

In some embodiments, determining the one or more agents of the plurality of agents that have a decrease in performance incudes determining a difference between the key performance indicators for a first time period and a second time period for each of the plurality of agents, and determining whether the difference is greater than a threshold. The threshold can be based on the KPI type and/or input by a user. Example thresholds can include a KPI of average handling time (AHT) that increases by 30 seconds or a first call resolution (FCR) decreases by 5%.

In some embodiments, determining a difference between the key performance indicators for a first time period and a second time period for each of the plurality of agents includes receiving as input a particular KPI (e.g., target KPI), a past time period (e.g., first time period), and a second time period (e.g., current time period). The inputs can be user input as received through a graphical user interface, retrieved from file, received by another computing system, or be a default value.

The past time period can be defined by a specific a start date and end date and/or the current time period can be defined by a specific start date and end date. The average value of the target KPI can be determined for the first time period and the second time period. Determining the average value can be implemented as an SQL query on top of a database.

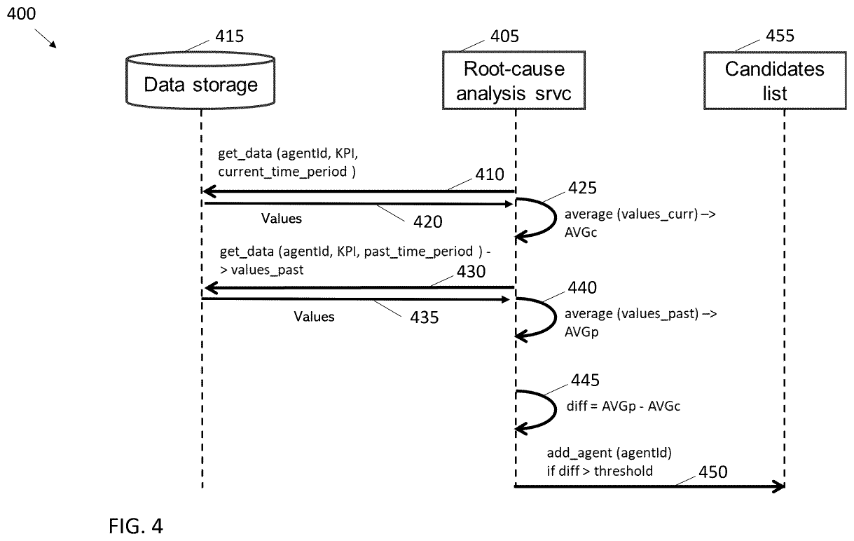

Turning to FIG. 4, FIG. 4 is a sequence diagram 400 for determining one or more agents of a plurality of agents that have a decrease in performance based on key performance indicators, according to some embodiments of the invention.

A root cause analysis service 405 (e.g., as implemented on a server) can transmit a first request to get data 410 to a data storage 415. The get data request 410 can include an identifier for an agent (e.g., agentId), KPI and a current time period. The values for the particular KPI for the particular agentId over the current time period can be returned 420 from the data storage 410 to the root cause analysis service 405. The root cause analysis service 405 can determine an average of the values 425.

The root cause analysis service 405 can transmit a second request to get data 430 to the data storage 415. The get data request 430 can include the agentId, the KPI and a previous time period. The values for the particular KPI for the particular agentId over the previous time period can be returned 435 from the data storage 410 to the root cause analysis service 405. The root cause analysis service 405 can determine an average of the values 440.

The root cause analysis service 405 can determine a difference between the average values for the current period and the average values for the previous period, and if the difference is above a threshold, then the agent that corresponds to agentId is transmitted 450 to a candidate list database 455. The candidate list database 455 can include a list of all agents of the plurality of agents that have had a decrease in performance.

Turning back to FIG. 2, the method can also involve for each of the one or more agents of the plurality of agents that have a decrease in performance (Step 220) performing steps 225, 230, 235 and 240 as described below.

The method can also include creating (e.g., by the processor) a first causal graph that is for a current time period (Step 225). The first causal graph can be a modification of the initial causal graph as described in Step 210. The first time period can be a current time period as described in FIG. 4. The method can also include creating (e.g., by the processor) a second causal graph that is for a second time period (Step 230). The second causal graph can be a modification of the causal graph as described in Step 205. The second time period can be a past time period as described in FIG. 4

Creating the first casual graph and the second casual graph can include, for each agent with a decrease in performance, collect values of the agent' metrics during the current time period and the past time period associated with each node in the initial casual graph; for each node in the initial causal graph, if there is a statistically significant change in the current node's metric's value between the current time period and the past time period, for the first causal graph (e.g., the current causal graph) use values from the current time period to train a linear regression model in the form: xᵢ=f(parents(xᵢ)+ϵ) where xᵢ is the current node, and ϵ is a self contribution factor, and set the trained linear regression model as a causal function of a given node in the current causal graph, and for the second causal graph (e.g., the past causal graph) use the data from the past period to train a linear regression model in the form: xᵢ=f(parents(xᵢ)+ϵ) where xᵢ is the current node, and ϵ is a self contribution factor, and set the trained linear regression model as a causal function of the given node in the past causal graph. If there is no statistically significant change in the current node's metric's value between the current time period and the past time period, then concatenate the current node's metric value for the current time period and the current node's metric value for the past time period, and use the concatenated values to train a linear regression model in the form: xᵢ=f(parents(xᵢ)+ϵ), where xᵢ is the current node, and ϵ is a self contribution factor, and set the trained linear regression model as a causal function as a causal function of a given node in both causal graphs.

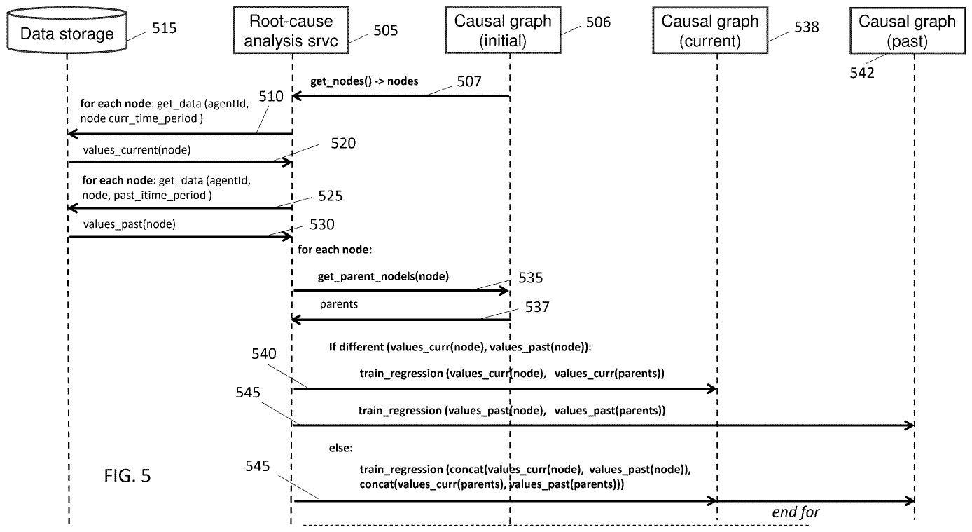

Turning to FIG. 5, FIG. 5 is a sequence diagram 500 for creating a current causal graph (e.g., first causal graph) and a past causal graph (e.g., second causal graph), according to some embodiments of the invention.

An initial causal graph, including a plurality of nodes, can be transmitted 507 to the root cause analysis service 505 (e.g., as implemented on a server).

A root cause analysis service 505 (e.g., as implemented on a server) can, for each node in the initial causal graph, transmit a first request to get data 510 to a data storage 515. The get data request 510 can include for each node, an agentId, node identification, and a current time period. The values for each node for the particular agentId over the current time period can be returned 520 from the data storage 510 to the root cause analysis service 505.

The root cause analysis service 505 can, for each node in the initial causal graph, transmit a second request to get data 525 to the data storage 515. The get data request 525 can include for each node, an agentId, node identification, and a past time period. The values for each node for the particular agentId over the past time period can be returned 530 from the data storage 510 to the root cause analysis service 505.

For each node in the initial causal graph 506, i) the root cause analysis service 505 can request 535 all parents from the initial causal graph and the parents can be returned to the root cause analysis service 537; ii) if values of the current node at the current time period are different than the values of the current node at the past time period, then for the current causal graph 538, train 540 a linear regression with the current node value at the current time period and the parent nodes at the current time period, and for the past causal 542 graph, train 545 a linear regression with the current node value at the past time period and the parent nodes at the past time period; else iii) train 550 a linear regression with concatenated value of the current node and the current time period and the past time period and a concatenated value of the parent nodes at the current time period and the past time period.

Turning back to FIG. 2, the method can also involve determining (e.g., by the processor) which of the key performance indicators is the root cause of a change in performance for the current one or more agent (Step 235).

Determining which of the key performance indicators is the root cause of change in performance for the current one or more agent can be based on the first causal graph and the second casual graph, as described above in FIG. 5.

In some embodiments, determining which of the key performance indicators is the root cause of change in performance for the current one or more agent can involve:
i) for a current causal graph, for all nodes in the graph, determine a remainder by subtracting an actual value of the current node in the current causal graph from the value predicted by the corresponding causal function for the current node, and determine an effect of the remainder on a target key performance indicator;
ii) for a past causal graph, for all nodes in the graph, determine a remainder by subtracting an actual value of the current node in the past causal graph from the value predicted by the corresponding causal function for the current node, and determine an effect of the remainder on the target key performance indicator;
iii) for every node compute the change in effect on the target key performance indicator by subtracting the current effect of the current node remainder on the target performance indicator from the past effect of the current node remainder on the target performance indicator; and
iv) after doing steps i) through iii) for all nodes, select the node that caused the highest change on the target key performance indicator. The target key performance indicator can be determined by a use. The target key performance indicator can be one of the nodes in the graph.

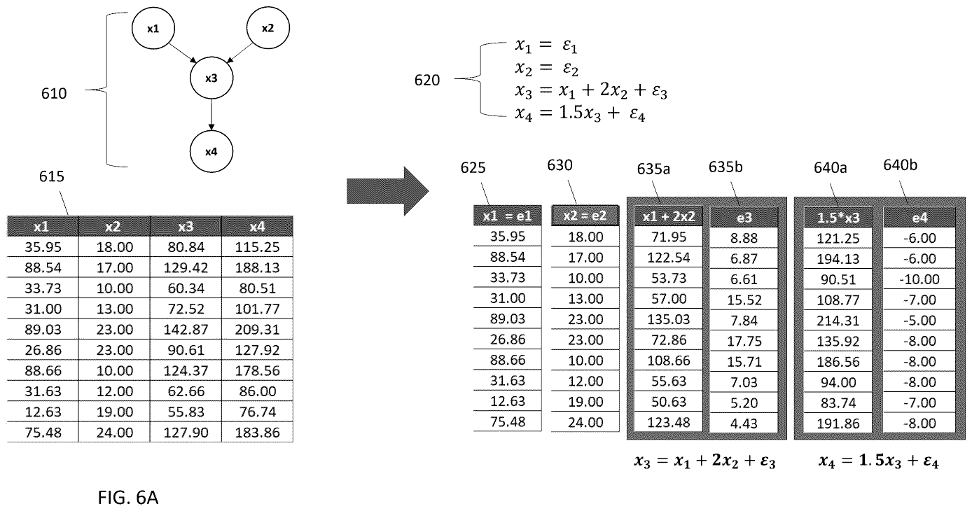

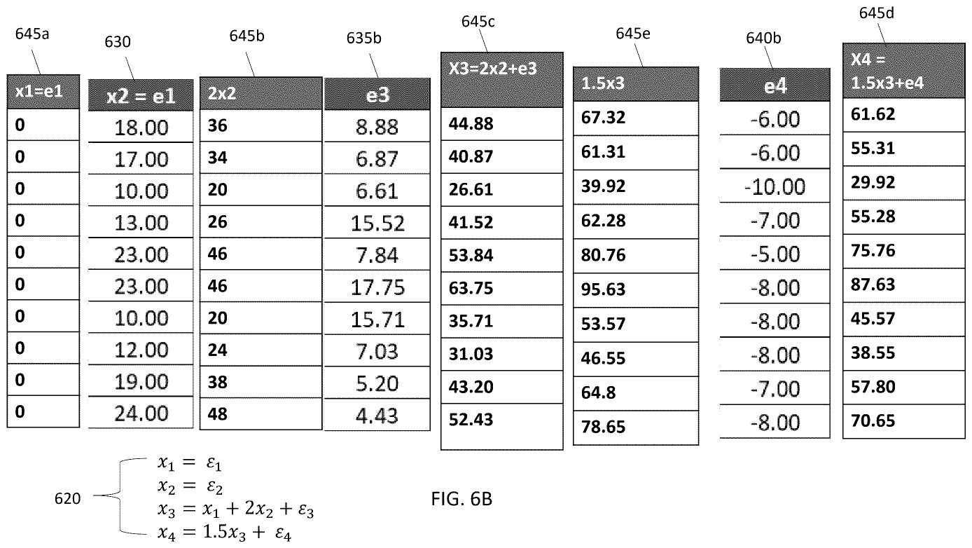

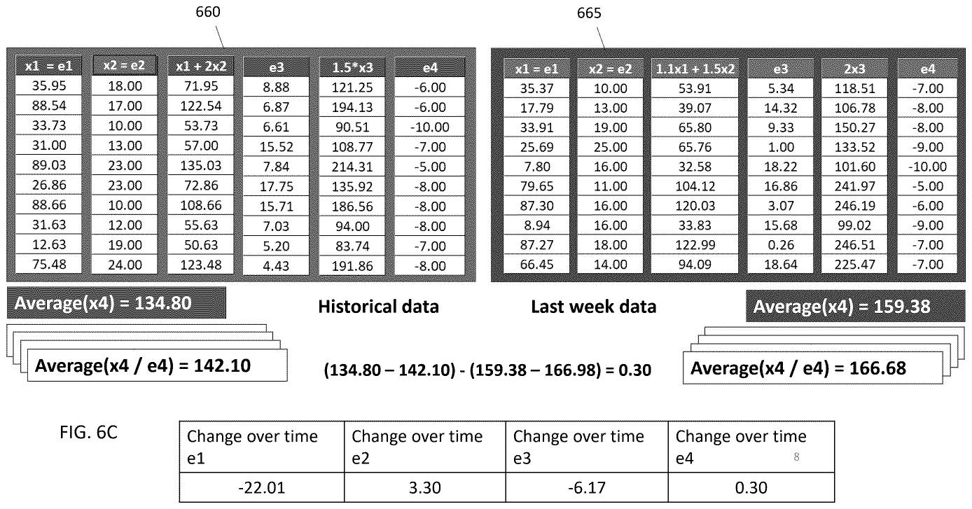

FIGS. 6A, 6B and 6C are an example of determining which of the key performance indicators is the root cause of change in performance, according to some embodiments of the invention. Determining which of the key performance indicators is the root cause can involve determining for each KPI a portion that identifies a contribution to the KPI from other KPIs and a portion that identifies a contribution to the KPI from the KPI itself.

As shown in FIG. 6A, assume a causal graph 610 having nodes x1, x2, x3 and x4. Each node can be a KPI, and its influence on other nodes can be seen in the causal graph. For example, KPI x4 is influenced by x3, x1 and x2, and node x3 is influenced by x1 and x2.Assume an input data set 615 for each of the nodes x1, x2, x3 and x4 over a predefined period of time (e.g., weekly or monthly). As is apparent to one of ordinary skill in the art, input data set 615 can include many more data points, e.g., on the order of 50 k-500 k. For example, a typical agent can have 500 calls per agent and there can be hundreds or even thousands of agents. The input data set 615 shown in FIG. 6A is for illustrative purposes.

As described above, each node can be split into two portions, where one portion represents a contribution to the KPI from other KPIs and a second portion that identifies the contribution to the KPI from the KPI. Assume each node has a linear regression model (e.g., causal function as shown above in FIG. 2) as shown in 620, where epsilon, ϵ, is a remainder (e.g., remainder as described above in FIG. 2). The remainder can be a self contribution factor of the node to its value. As described above, the linear regression model can be trained for each KPI, metric and/or behavior.

Evaluating the linear regression model for x1 results in the original values as shown in a first modified dataset 625, as x1 is simply itself, meaning no other node contributes to the value of x1. Evaluating the linear regression model for x2 results in the original values as shown in a second modified dataset 630, as x2 is simply itself, meaning no other node contributes to the value of x2.

Evaluating the linear regression model for x3, x1+2×2 without the term ϵ3 (or e3 as shown) results in a change of values resulting a third modified dataset 635a. Subtracting the third modified dataset 635a from the original value, x3 results in the remainder (e.g., the self contribution factor) ϵ3. For example, x3 first row value is 80.84. Evaluating x1+2×2=71.95. Subtracting x1+2×2 (71.95) from x3 (80.84) is ϵ3 (8.88).

Evaluating the linear regression model for x4 without the term ϵ4 (or e4 as shown) results in a change of values resulting a fourth modified dataset 640a. Subtracting the fourth modified dataset 640a from the original value, x4 results in the remainder (e.g., the self contribution factor) ϵ4. For example, x4 first row value is 115.25. Evaluating 1.5×3=121.25. Subtracting 1.5×3 (121.25) from x4 (115.25) is ϵ4 (−6.00).

Turning to FIG. 6B, FIG. 6B shows an example of how to measure an effect of the self-contributing value on a target KPI. The effect of the self-contributing factor can be determined by removing each remainder from the target KPI to isolate its effect on the target KPI. For example, assume x4 is the target KPI. The remainders can be removed one by one. The remainder can be removed evaluating each of the linear equations 620 with the remainder removed (e.g., set to zero).

For example, assume the target KPI of x4. The average of the original input data set 615 x4 as shown in FIG. 6A is 134.80. To remove the effect of a remainder e1, e1 can be changed to zero and the linear equations 620 reevaluated. In this example, setting e1 to zero results in x1 equal to zero 645a; x2 remains unchanged; x3 is x1+2×2+e3, with term 2×2 shown in 640b. Removing e1 results in x3 results in 2×2+e3 640c; and x4 revaluated with e1 removed is 1.5×3 640d, with term 1.5×3 640e. The average of target KPI x4 with e1 removed is 57.80.

The average of target KPI x4 with e2 removed 84.10, the target KPI x4 with e3 removed 120.43, and the target KPI x4 with e4 removed is 142.10.

The effect of e1 on target KPI x4 can be determine by subtracting the average of x4 from the average of target KPI x4 with e1 removed, particularly 134.80−57.80=77. The effect of e2 on target KPI x4 can be determine by subtracting the average of x4 from the average of target KPI x4 with e2 removed, particularly 134.80−84.10=50.70. The effect of e3 on target KPI x4can be determine by subtracting the average of x4 from the average of target KPI x4 with e3 removed, particularly 134.80−120.43=14.37. The effect of e4 on target KPI x4 can be determine by subtracting the average of x4 from the average of target KPI x4 with e4 removed, particularly 134.80−142.10=−7.3. Depending on the type of the target KPI, a higher value indicates a higher contribution and a lower value indicates a lesser contribution, or a lower value indicates a higher contribution and a higher value indicates a lesser contribution. For example, in evaluation a target KPI of average handling time, a smaller value is better. In this manner, a determination of which remainder has a biggest impact on the target KPI (e.g., a root) can be made.

FIG. 6C shows results of the linear regression models 620 applied to a data set for a current time period 665 (e.g., last week data) and a dataset for a historical (e.g., past) time period 660 (e.g., as shown above in FIGS. 6A and 6B) with the effects of remainders considered, according to some embodiments of the invention.

For each time period, the current and historical, the effect of the remainders of on target KPI x4 can be determined. In some embodiments, the causal effect modeled by the linear regression can change over time, such that a particular KPI can have its linear regression changed. For example, as shown in FIG. 6C the target KPI x4 has a linear regression of 1.5×3+e4 in the historical data, and in the current data a linear regression of 2×3. The current data 665 can be determined as described in FIG. 6B.

A determination of how a remainder effects a particular target KPI over time can be determined. As described in FIG. 6B, in the past dataset 660, the average of the target KPI x4 is 134.80. In the past dataset 660, the average of the target KPI x4 with remainder e4 removed is 142.10. In the current dataset 665, the average of target KPI x4 is 159.38. In the current dataset 664, the average of target KPI x4 with remainder e4 removed is 166.68.

To determine the effect of any remainder on a target KPI over time can be determined as shown below in EQN. 1:

(Average of historical target KPI−Average the historical target KPI with the remainder removed)−(Average current target KPI−Average of current target KPI with the remainder removed) (1)

Continuing with the example in FIG. 6C, comparing the current dataset and the past dataset 660 for target KPI x4 with remainder x4 removed is (134.80−142.10)−(159.38-166.98)=0.30. Performing the same determination for e3, e2 and e1 results in −6.17, −3.30, and −22.01, respectively. In this manner, a determination of which remainder caused a biggest change in effect on the target KPI over time can be determined.

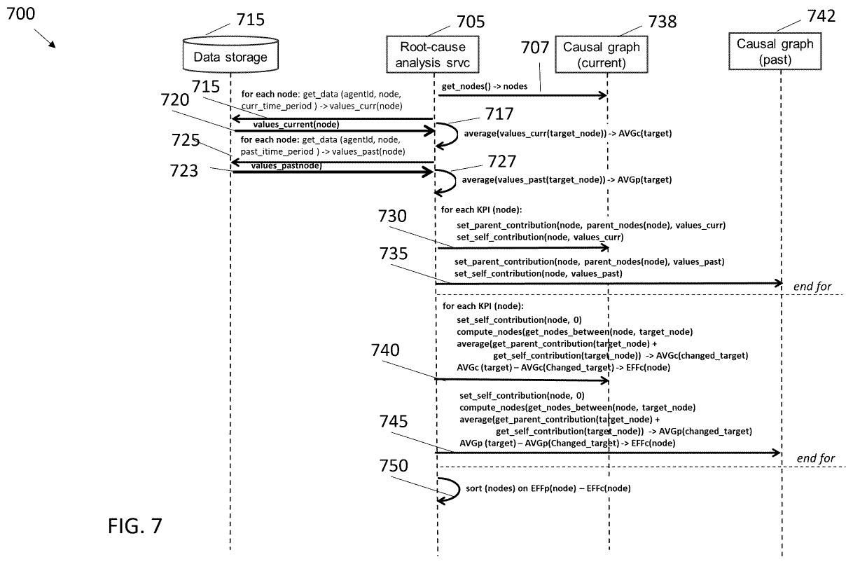

Turning to FIG. 7, FIG. 7 is a sequence diagram 700 for determining which of the key performance indicators it the root cause of change in performance for the current one or more agent, according to some embodiments of the invention.

A plurality of nodes of a current causal graph can be transmitted 707 to the root cause analysis service 705 (e.g., as implemented on a server).

A root cause analysis service 705 (e.g., as implemented on a server) can, for each node in the plurality of nodes, transmit a first request to get data 710 to a data storage 715. The get data request 710 can include for each node, an agent identifier (e.g., agentId), node identification, and a current time period. The values for each node for the particular agentId over the current time period can be returned 720 from the data storage 710 to the root cause analysis service 705.

The root cause analysis service 705 can determine an average 717 of the values for a target KPI for the current time period.

The root cause analysis service 705 can, for each node in the plurality of nodes, transmit a second request to get data 710 to a data storage 715. The get data request 710 can include for each node, an agentId, node identification, and a past time period. The values for each node for the particular agentId over the current time period can be returned 723 from the data storage 710 to the root cause analysis service 705.

The root cause analysis service 705 can determine an average 727 of the values for the target KPI for the past time period.

For each node in the current causal graph, get parents of the current node. If a number of parents is greater than zero, obtain causal function of the current node from the current causal graph, set parent contribution of the current node to be the result of applying the causal function on the values of the parents'nodes, and set a self contribution value of the current node to be the difference between the actual values in current value and the parent contribution. If a number of parents is zero, set the parent contribution of the current node to be zero and set the self contribution value of the current node to be the actual values of the node in current time period value 730.

For each node in the past causal graph, get parents of the current node. If a number of parents is greater than zero, obtain causal function of the current node from the past causal graph, set parent contribution of the current node to be the result of applying the causal function on the values of the parents'nodes, and set a self contribution value of the current node to be the difference between the actual values in current value and the parent contribution. If a number of parents is zero, set the parent contribution of the current node to be zero and set the self contribution value of the current node to be the actual values of the node in past time period value 735.

For each node in the current causal graph, replace self contribution values of the current node (e.g., remainders) with zeros. Determine an ordered list of nodes connecting the current node to a target node (e.g., target KPI). For each node in the ordered list of nodes including the target node, recalculate their parent contribution values by running their respective causal function with their parent values. Compute an effect of the current node by subtracting the average of the recalculated parent contribution values and an average of the original parent contributions values 740.

For each node in the past causal graph, replace self contribution values of the current node (e.g., remainders) with zeros. Determine an ordered list of nodes connecting the current to a target node (e.g., target KPI). For each node in the ordered list of nodes including the target node, recalculate their parent contribution values by running their respective causal function with their parent values. Compute an effect of the current node by subtracting the average of the recalculated parent contribution values and an average of the original patent contributions values 745.

Subtract and effect of the current node on the target node in the current data set from the effect of the current node on the target node in the past dataset. Sort the effect of the nodes from the current time period and past time period in descending order, and return top nodes 750.

Turning back to FIG. 2, the method can also involve transmitting (e.g., by the processor) the root cause to another computing system that selects a coaching program to run based on the root cause, to another computing system that selects which interactions to record, to a display, or any combination thereof (Step 240).

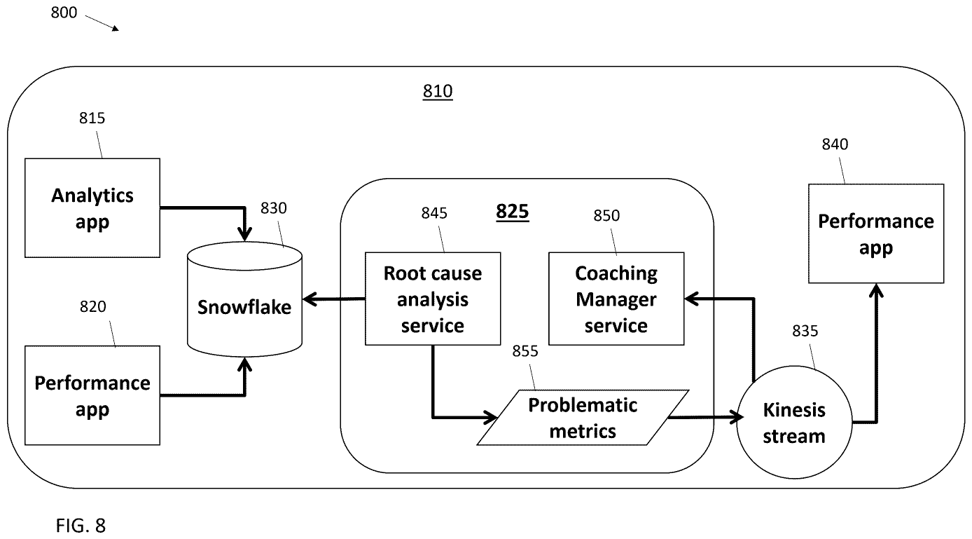

FIG. 8 is a system architecture 800 for a cloud-based contact center 810, according to some embodiments of the invention. The cloud-based contact center 810 includes an analytics application 815, a first performance application 820, a coaching application 825, database 830 (e.g., snowflake), a kinesis stream 835, and a second performance application 840.

The coaching application 825 can include a root cause analysis service 845, coaching management service, and a problematic metrics module 855.

The first performance application 820 can produce metric data (e.g., per agent interaction) and store the metric data in the database 830. The first performance application 820 can use the metric data to produce metrics and KPIs per agent.

The root cause analysis service 845 can obtain the metrics and KPIs per agent (e.g., in the contact center and/or specific team). The root cause analysis service 845 can be invoked automatically at a predetermined time frequency (e.g., weekly or monthly), and/or with respect to a particular team. In some embodiments, the root cause analysis service 845 from the coaching application 825.

The root cause analysis service 845 can perform according to the description above, identifying a root cause for one or more agents decrease in performance. The root cause can be transmitted from the root cause analysis service 845 to automatically creating coaching opportunity.

The list of metrics can be shared through the cloud, e.g., stream (e.g., the AWS Kinesis stream), messaging queue, and/or S3, where they can be used by the coaching manager service 850 to automatically create a coaching package and/or by a second performance application to automatically select relevant interactions for evaluation.

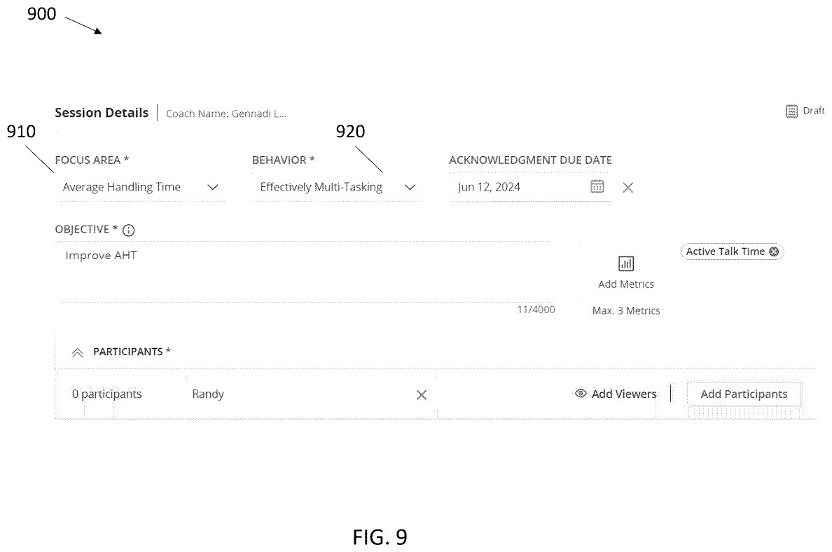

Turning to FIG. 9, FIG. 9 shows an example of a coaching package graphical user interface 900, according to some embodiments of the invention. The fields of focus area 910 and/or behavior 920 can be automatically populated based on the output of the root cause analysis service which identified a root cause of an agents decrease in performance.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A computerized method for evaluating and determining a root cause of a change in performance in a workforce management system, the computerized method comprising:
determining, by a processor, a causal graph based on key performance indicators, behaviors, and metrics;
determining, by the processor, one or more agents of a plurality of agents that have a decrease in performance based on key performance indicators; and
for each of the one or more agents:
i) creating, by the processor, a first causal graph that is for a current time period;
ii) creating, by the processor, a second causal graph that is for a second time period;
iii) determining, by the processor, which of one or more metrics, one or more behaviors or a combination thereof is the root cause of a change in performance for the current one or more agent;
iv) transmitting, by the processor, the root cause to another computing system that selects a coaching program to run based on the root cause, to another computing system that selects which interactions to record, to a display, or any combination thereof.

2. The method of claim 1, wherein determining the one or more agents that have a decrease in performance further comprises determining a difference between the key performance indicators for a first time period and a second time period for each of the plurality of agents.

3. The method of claim 1, wherein creating the first casual graph and the second causal graph further comprises training a linear regression based on nodes of the respective causal graph and edges of the respective causal graph.

4. The method of claim 1 wherein the one or more metrics, one or more behaviors or a combination thereof, that the causal graph is based on are received from a database, input through a graphical user interface, or any combination thereof.

5. The method of claim 1 wherein determining the root cause further comprises, for each node in the first causal graph, isolate a contribution from other nodes to the value of the respective node from the contribution of the node itself to the value of the respective node.

6. The method of claim 5 wherein determining the root cause further comprises identifying which node has a biggest effect on the value and whether a change in value has a negative or positive effect on performance based on a type of the one or more metrics or the one or more behaviors of the node.

7. The method of claim 1 wherein determining one or more agents that have decreased in performance further comprising receiving, by the processor, the key performance indicators from another computing device, a graphical user interface, or any combination thereof.

8. A system for evaluating and determining a root cause of a change in performance in a workforce management system, the system comprising:
a computing device;
a memory; and
a processor, the processor configured to:
determine a causal graph based on key performance indicators, behaviors, and metrics;
determine one or more agents of a plurality of agents that have a decrease in performance based on key performance indicators; and
for each of the one or more agents:
v) create a first causal graph that is for a current time period;
vi) create a second causal graph that is for a second time period;
vii) determine which of one or more metrics, one or more behaviors or a combination thereof is the root cause of a change in performance for the current one or more agent;
viii) transmit the root cause to another computing system that selects a coaching program to run based on the root cause, to another computing system that selects which interactions to record, to a display, or any combination thereof.

9. The system of claim 8, wherein to determine the one or more agents that have a decrease in performance the processor is further configured to determine a difference between the key performance indicators for a first time period and a second time period for each of the plurality of agents.

10. The system of claim 8, wherein to create the first casual graph and the second causal graph the processor is further configured to train a linear regression based on nodes of the respective causal graph and edges of the respective causal graph.

11. The system of claim 8, wherein the one or more metrics, one or more behaviors or a combination thereof, that the causal graph is based on are received from a database, input through a graphical user interface, or any combination thereof.

12. The system of claim 8, wherein to determine the root cause the processor is further configured to for each node in the first causal graph, isolate a contribution from other nodes to the value of the respective node from the contribution of the node itself to the value of the respective node.

13. The system of claim 12, wherein to determine the root cause the processor is further configured to identify which node has a biggest effect on the value and whether a change in value has a negative or positive effect on performance based on a type of the one or more metrics or the one or more behaviors of the node.

14. The system of claim 8, wherein to determine one or more agents that have decreased in performance the processor is further configured to receive the key performance indicators from another computing device, a graphical user interface, or any combination thereof.

15. A non-transitory computer program product comprising instruction which, when the program is executed cause the computer to:
determine a causal graph based on key performance indicators, behaviors, and metrics;
determine one or more agents of a plurality of agents that have a decrease in performance based on key performance indicators; and
for each of the one or more agents:
i) create a first causal graph that is for a current time period;
ii) create a second causal graph that is for a second time period;
iii) determine which of one or more metrics, one or more behaviors or a combination thereof is a root cause of a change in performance for the current one or more agent;
iv) transmit the root cause to another computing system that selects a coaching program to run based on the root cause, to another computing system that selects which interactions to record, to a display, or any combination thereof.

16. The non-transitory computer program product of claim 15, wherein to determine the one or more agents that have a decrease in performance the processor is further configured to determine a difference between the key performance indicators for a first time period and a second time period for each of the plurality of agents.

17. The non-transitory computer program product of claim 15, wherein to create the first casual graph and the second causal graph the processor is further configured to train a linear regression based on nodes of the respective causal graph and edges of the respective causal graph.

18. The non-transitory computer program product of claim 15, wherein the one or more metrics, one or more behaviors or a combination thereof, that the causal graph is based on are received from a database, input through a graphical user interface, or any combination thereof.

19. The non-transitory computer program product of claim 15, wherein to determine the root cause the processor is further configured to for each node in the first causal graph, isolate a contribution from other nodes to the value of the respective node from the contribution of the node itself to the value of the respective node.

20. The non-transitory computer program product of claim 19, wherein to determine the root cause the processor is further configured to identify which node has a biggest effect on the value and whether a change in value has a negative or positive effect on performance based on a type of the one or more metrics or the one or more behaviors of the node.
